(19) United States
(12) Patent Application Publication
(10) Pub. No.: US 2002/0184324 A1
(43) Pub. Date: Dec. 5, 2002

(54) Method and system for electronic commingling of hybrid mail

(76) Inventors: Paul N. Carlin, McLean, VA (US); Eugene C. Johnson, Chevy Chase, MD (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/105,614

(22) Filed: Mar. 25, 2002

Related U.S. Application Data
(63) Continuation-in-part of application No. 09/549,161, filed on Apr. 13, 2000.

(51) Int. Cl. G06F 15/16; G06F 9/00

(52) U.S. Cl. 709/206; 709/100

(57) ABSTRACT

A plurality of hybrid mail jobs from one or more sources are received at a hybrid mail facility in the form of sets of variable data. The variable data are merged with designated fixed data to produce a plurality of individual print files containing page images to be printed. The individual print files are electronically commingled to produce a single commingled print file containing multiple mail jobs. Presorting is performed to order the commingled print file in accordance with sorting criteria. Before production of the finished mail pieces, the commingled print file, if necessary, is divided into a plurality of divided print files corresponding to different classes requiring different printer and/or automated inserter set-ups.

### CROSS-REFERENCE TO RELATED APPLICATION

This application is a continuation-in-part of U.S. application Ser. No. 09/549,161, filed Apr. 13, 2000, entitled “Method and System for Hybrid Mail with Distributed Processing,” the contents of which are hereby incorporated by reference.

### FIELD OF THE INVENTION

The present invention relates to distributed hybrid mail. More particularly, it relates to electronic commingling of hybrid mail transmitted electronically.

### BACKGROUND OF THE INVENTION

Hybrid mail has been utilized since about 1970. Hybrid mail consists of variable data and fixed information. Variable data includes that which varies from letter to letter, such as name and address. Fixed information includes, for example, the format and content of the letter. Hybrid mail is traditionally produced using a central facility. Most of these central facilities typically utilize a large main frame computer at the central facility to control the processing of producing hybrid mail. Hybrid mail can be processed in a number of different ways. In one conventional scheme, such as that described in U.S. Pat. No. 5,802,530 to Sansone, a message that is intended to become a part of a batch of hybrid mail for a particular mass mailing is input and processed at a central computer. The central computer matches variable data with the fixed information and creates a printable image in an electronic file for each hybrid mail piece. The entire printable image for each hybrid mail piece, including all of the fixed and variable information, is distributed in a spoke and hub method from the central computer to print facilities. Each of those finished mail pieces in that batch are printed, then presorted and mailed.

In the above-described technique, the image data transmitted from the central computer to the print facilities includes both fixed and variable data. It has been observed that the fixed data that is included in a hybrid mail piece constitutes about seventy percent (70%) of a letter while the variable data constitutes only about thirty percent (30%) of the information. The amount of data that must be transmitted to the print facilities can be quite large. A significant drawback to the above-described system is that the majority of this data is fixed data, and hence the repeated transmission of this fixed data is redundant and therefore wasteful.

A second technique for processing hybrid mail is described in U.S. Pat. No. 5,918,220, also to Sansone. In this technique, it is possible to send a set of parameters, which includes address data and text identifying data or the text itself, to a print facility. When text identifying data is sent, it is used to select text that is stored locally at the print facility. While this system does provide the ability to eliminate duplicate data, it requires each print facility to store text locally. This creates a problem when a text selection must be changed as the change must be made at each print facility. Additionally, when the text is confidential, the existence of copies at multiple print facilities presents a security risk.

Conventional systems, generally speaking, merely automate the process of constructing a finished mail piece. Nevertheless, conventional systems do not provide any way to track a piece of mail as it progresses through production of the hybrid mail piece. Also, since these systems merely automate a formerly manual process, the mail piece is not delivered to the addressee any faster than conventional mail.

In order to address the above-noted shortcomings, a new method for processing hybrid mail was developed as described in co-pending U.S. application Ser. No. 09/549,161, entitled “Method and System for Hybrid Mail with Distributed Processing,” the contents of which are incorporated by reference herein. In one embodiment of that system, customers send mail jobs (comprised of a plurality of variable data including addresses to which mail pieces are to be delivered) to one of several gateways where the variable data is sorted, for example by geographic location of the addresses. The gateway then partitions the mail job among one or more Mail Production Facilities (MPFs), which are geographically diverse, and sends a corresponding portion of the variable data to one or more MPFs. When an MPF receives variable data from a gateway, the MPF requests fixed data from a central System Management Facility (SMF) that serves all of the MPFs, and the SMF transmits the fixed data to the MPF. The MPF merges the variable data with the fixed data and uses the merged data to form a print file, which contains images of each page to be printed. The print file is then printed to create the mail piece. The variable data is preferably buffered in the MPF for a period of time and is then discarded by the MPF. In this manner, security and ease of update for fixed data is maintained while avoiding the wastefulness associated with repeated transmission of fixed data.

The new system described above represents a significant advance in hybrid mail processing. However, the system does not particularly address another aspect of hybrid mail that is of importance to senders of such mail, namely, achieving the lowest possible postage rate for a given sender's mail jobs. Under existing regulations of the United States Postal Service, discounts in postage rates can be achieved by presorting mail pieces into bundles in accordance with one or more parameters such as the zip code's first three digits, the full zip code, the so-called zip+4 code, and the carrier route. Thus, for example, all mail pieces in a given bundle may have the same zip code or zip+4 code. To qualify for lower postage rates, however, the number of mail pieces in the bundle must exceed a certain threshold. A relatively small-volume sender likely would not have enough mail pieces to qualify for the lower rates, once the mail pieces are presorted into the different sorting categories.

This problem was addressed in U.S. Pat. No. 5,377,120, which describes an apparatus for physically commingling and addressing mail pieces. The apparatus takes pre-printed, unaddressed mail pieces from various senders and combines the mail pieces to create mailing bundles of sufficient size to qualify for postage discounts. This system requires that the mail pieces be printed for each sender, then transported to a shared facility at which the pieces from the various senders are presorted and combined into bundles. The bundles are then delivered to a post office for mailing to the addressees. A drawback of this system is the requirement of transporting the printed mail pieces to the shared facility, not to mention the need for complex machinery to physically commingle mail pieces that may be of various sizes and configurations.

### SUMMARY OF THE INVENTION

The present invention addresses the aforementioned needs by providing a system and method for electronically commingling hybrid mail jobs. In accordance with one aspect of the invention, a method comprises steps of: receiving at a hybrid mail facility a plurality of mail jobs from a plurality of senders, each mail job comprising variable data corresponding to a plurality of mail pieces to be produced; generating an electronic data file for each mail job based on the variable data thereof, such that there are a plurality of said electronic data files; and composing a commingled print file from the plurality of electronic data files, the commingled print file containing images to be printed for each of the plurality of mail jobs, the images including variable data and fixed data. Thus, when the commingled print file is printed, the result is a batch of commingled mail pieces that can then be inserted into envelopes by an automated inserter.

In a preferred embodiment of the present invention, a separate print file for each mail job is created using the variable data. The print file contains printable page images, including variable and/or fixed data, for each page in each mail piece (excluding pre- printed inserts). Along with the print file, a journal file is created. The journal file includes an entry for each mail piece in the mail job. The entry includes the address information and the location in the print file of the page images for the mail piece. Because the print file is created separately for each job, there is no chance that variable data from one customer will be combined with fixed data for another customer. This feature greatly enhances security and accuracy.

Once the print files and journal files for each separate mail job are created, the print and journal files are commingled. That is, the print files from separate jobs are combined, using the journal files as an index, such that a single print file including mail pieces from separate mail jobs (customers) is created. Preferably presorting is performed before or after the print files are commingled. The step of presorting, in one embodiment, includes assigning a container code to each mail piece, the container code indicating which of a plurality of mail containers the mail piece is to be placed in after the mail piece is finished. In one embodiment, the journal files are commingled to produce a commingled journal file, the commingled journal file is presorted, and then a commingled print file is composed based on the presorted commingled journal file. Thus, the result is a single presorted print file composed of multiple mail jobs. Performing the presort on the commingled jobs as a whole allows greater cost savings to be realized. Prior to the present invention, mail jobs were run separately and manually commingled after all jobs were completed. This manual process was time consuming and therefore expensive. By electronically commingling the mail jobs, significant cost reductions may be realized.

In accordance with still other embodiments of the invention, a unique identifier is assigned to each image in a mail piece such that each printed page in the finished mail piece includes the identifier. The identifier on each page is read before inserting the page into an envelope to ensure that the page is inserted into the correct envelope.

Further preferred embodiments of the present invention provide for commingling of mail jobs that cannot be processed by the printer and/or inserting equipment at the same time. Standard high speed printers used in the hybrid mail industry are only capable of printing on a single type of paper at one time. Standard inserting equipment is limited in that only a limited number of envelope configurations and a limited number of different inserts can be handled by the insertion equipment at any one time. Therefore, when separate mail jobs are commingled, it may not be possible for the printer and/or the insertion equipment to handle all of the different print paper, inserts and envelopes required. This is accounted for by assigning classes to jobs. The class defines all of the paper, insertion, and envelopes requirements for a job. After the electronically commingled print and journal files are formed, they are broken down into divided files by class. When classes for jobs are such that more than one class may be handled by the printer and insertion equipment at the same time, those jobs are placed in the same divided files. The printer and insertion equipment are configured for the first divided files, the divided files are printed and processed by the insertion equipment, the insertion machine is then reconfigured and subsequent divided files are processed until all mail pieces in the original commingled file have been completed. The mail pieces from each of the divided files are directed toward containers such as letter trays in such a manner that the separate classes of print jobs are automatically commingled. Thus, mail pieces from a first print job are directed toward trays such that spaces are left in the trays for mail pieces from subsequent mail jobs in different classes. The result is that a single tray may include mail pieces from different classes.

In accordance with the invention, a system for processing hybrid mail comprises a network of processing facilities operable to receive first variable data from a first customer and merge the first variable data with fixed data to form a first print file containing first images to be printed, to receive second variable data from a second customer and merge the second variable data with fixed data to form a second print file containing second images to be printed, to combine the first and second print files into a single commingled print file containing the first and second images, and to print the commingled print file to produce pages for insertion into finished mail pieces, whereby electronic commingling of customers' mail jobs occurs only after the images are created.

In a preferred embodiment, the system includes a plurality of gateways each operable to receive sets of variable data from one or more customers. The system also includes a first processor that splits each set into a plurality of split variable data sets in accordance with at least one criterion for distribution of the variable data (e.g., geographical location for which the mail pieces are destined), and distribute the split variable data sets to a plurality of mail processing facilities based on the distribution criterion. The system further includes a plurality of mail processing facilities each including a second processor, a printer, and an inserter. The second processor composes a separate print file for each split variable data set received, combines the separate print files into a commingled print file, inserts a mail piece identifier into at least one image of each mail piece in the print file, divides the print file into a plurality of divided print files based on a class associated with each set of images, and transmits the divided print files to the printer for printing.

### BRIEF DESCRIPTION OF THE DRAWINGS

The above and other objects, features, and advantages of the invention will become more apparent from the following description of certain preferred embodiments thereof, when taken in conjunction with the accompanying drawings in which: [The above-mentioned and other advantages and features of the present invention will become more readily apparent from the following detailed description and the accompanying drawings in which:

FIG. 1 is a block diagram of a distributed hybrid mail system in accordance with one preferred embodiment of the invention;

FIG. 2 is a diagrammatic representation of a mail processing facility;

FIG. 3 depicts processes performed at a gateway;

FIG. 4 depicts processes performed at a mail processing facility;

FIG. 5 is a data flow diagram illustrating composition and file generation;

FIG. 6 is a data flow diagram illustrating electronic commingling; and

FIG. 7 is a data flow diagram illustrating class division.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will filly convey the scope of the invention to those skilled in the art. Like numbers refer to like elements throughout.

The following detailed description of preferred embodiments includes many specific details such as numbers and type of inserts. The inclusion of such details is for the purpose of illustration only and should not be understood to limit the invention.

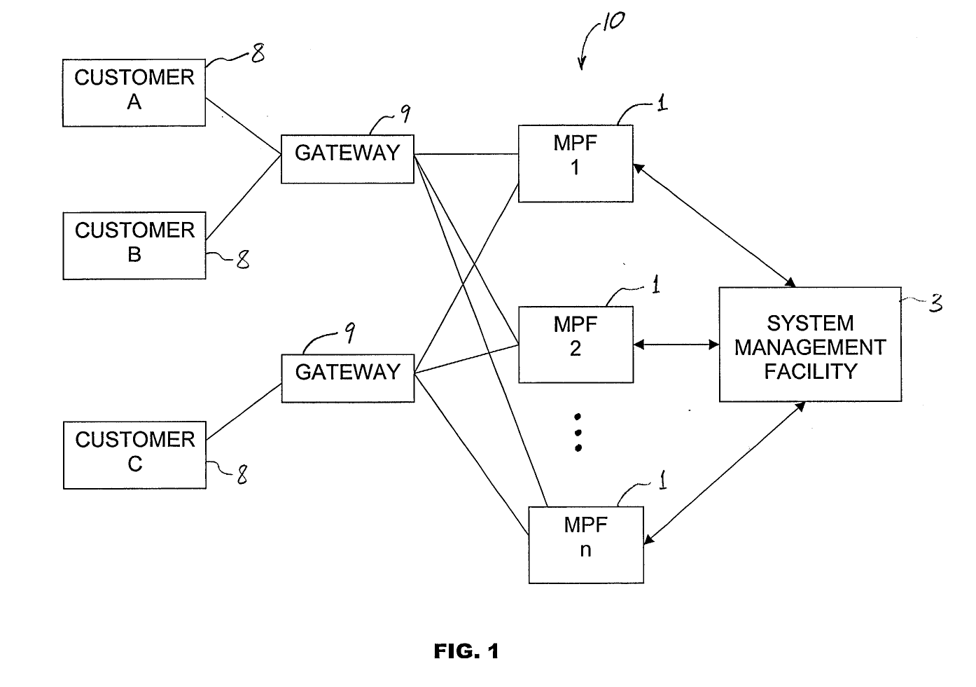

In preferred embodiments, a distributed hybrid mail system 10, as illustrated in FIG. 1, includes a plurality of mail production facilities (MPFs) 1, at least one system management facility (SMF) 3, and a plurality of customer gateways 9. The customer gateways 9 provide an entry point through which customer computers 8 may send variable data to the system 10. The gateways 9 may be physically located at the customer site or elsewhere, including the location where the SMF 3 or any MPF 1 is situated. In preferred embodiments, each customer is assigned a unique gateway 9, although it is possible for customers 8 to share a gateway, such as the gateway 9 shared by customers A and B. Communications between the various facilities of the system 10 may accomplished using conventional communications technology and are preferably secure. The SMF 3, which acts as the central point for coordinating mail jobs, preferably comprises a processor and mass storage devices such as hard disks or RAID (redundant array of inexpensive disks) devices. Although only a single SMF 3 is illustrated in FIG. 1, a redundant SMF 3 is provided in preferred embodiments.

As shown in FIG. 2, each MPF 1 preferably comprises a processor 100 and associated mass storage device, a printer 102 connected to the processor to receive images to be printed, and an inserter 104, which performs the tasks associated with placing the material output by the printer and associated inserts into envelopes. Tasks that are advantageously performed by the gateways 9, SMF 3, and MPFs 1 are discussed below.

In a preferred embodiment, an incoming mail job from a customer computer 8 is received at that customer's assigned gateway 9. The incoming mail job includes an identification of the customer, an identification of the application program (described in detail below) associated with the mail job, and the variable data for that mail job.

Referring now to FIG. 3, at the gateway 9, a process referred to in the art as hygiene 201 preferably is performed on the variable data. In the hygiene process 201, the address information undergoes CASS (Coding Accuracy Support System) certification under available standards. Special discounts are available from the U.S. Postal Service for mail pieces that are coded with certain information including the five digit zip code, zip+4 code, the delivery point code and the carrier routing code. In order to take advantage of this discount, however, this information must be CASS certified for accuracy periodically, currently at least once every 6 months (that is, the zip code and other information for each street address in a mail job must have been CASS certified at least once in the preceding six months). In the CASS certification process, the street address information for a mail piece is compared against a database provided by the USPS. The correct five digit zip code, zip+4 code, the delivery point code and the carrier routing code for the street address are determined and the variable data from the customer is updated with the correct information as necessary. The CASS certification is preferably performed for each street address in the mail job. For non-U.S. Postal Service mail, other standards or certification processes may be performed to “scrub” the mail job. The step of performing hygiene 201 may be omitted, but there is likely to be reduced quality.

In addition to CASS certification, address correction 203 is performed in preferred embodiments. Preferably, address correction in the U.S. is accomplished using the FAST FORWARD database provided by the USPS. However, a number of other methods for correcting addresses are known and may be used. Further, non-U.S. addresses may be corrected using known methods. Address correction is also preferably performed for each name in the mail job. Performing address correction for each name as it is received represents a dramatic improvement over known systems and helps to ensure the accuracy of the mail job.

Also performed at the gateway 9 (or alternatively at an MPF 1 or the SMF 3) is a class assignment process 204 in which each mail piece of each job is assigned to one of a plurality of different classes based on the resources required to print the pages of the mail piece and insert the pages into an envelope. For example, some mail pieces may require one type of envelope while other mail pieces may require a different type of envelope; likewise, the paper on which the mail pieces are to be printed may be different for the various pieces, and different pre-printed inserts may be required for the various pieces. Each class defines the set of resources required to produce the mail pieces of that class.

The incoming mail job then undergoes a splitting process 205 in which it is split into smaller mail jobs that are sent to individual, geographically distributed MPFs. The variable data is therefore broken down into smaller mail jobs according to the geographic destinations of the mail pieces such that the jobs can be sent to various MPFs closest to the respective destinations, which serves to reduce mail delivery time. However, in instances where mail jobs include special requirements (such as inserts or envelopes with special sizes) that cannot be handled at all MPFs 1, or where a particular MPF 1 is too busy to handle a mail job, the mail job may be redirected to another MPF 1 that has the requisite processing capabilities to handle the job. The SMF 3 preferably keeps track of the processing capabilities and work load of each MPF 1 in order to make this decision.

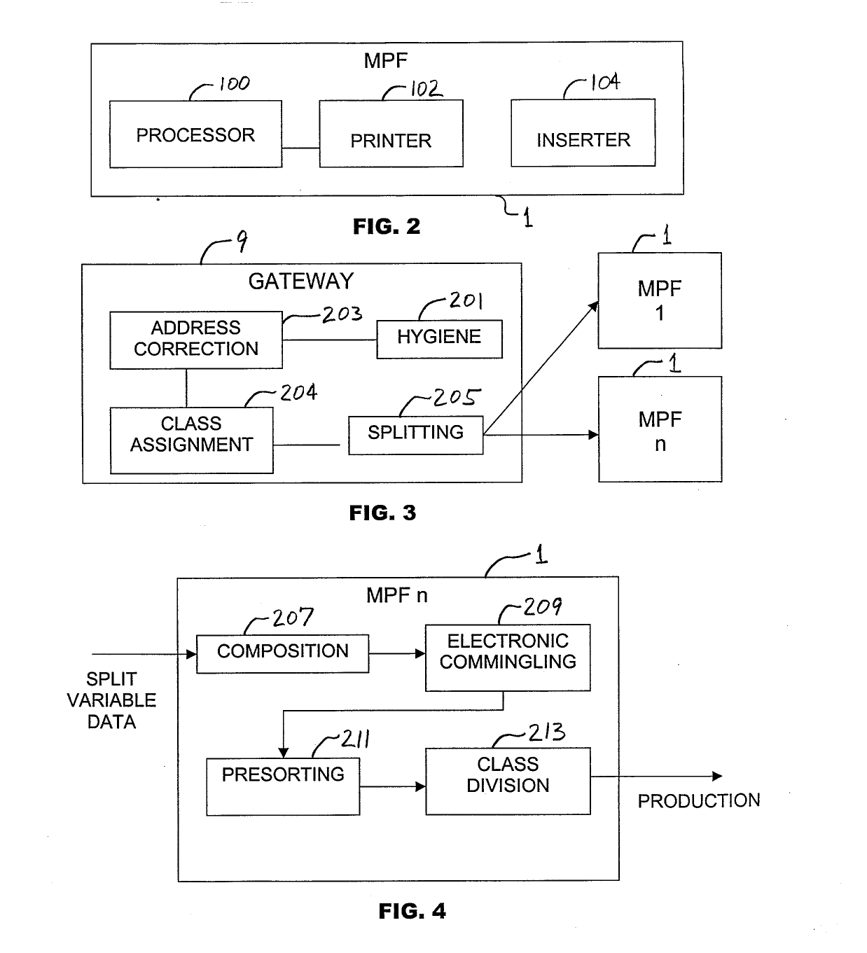

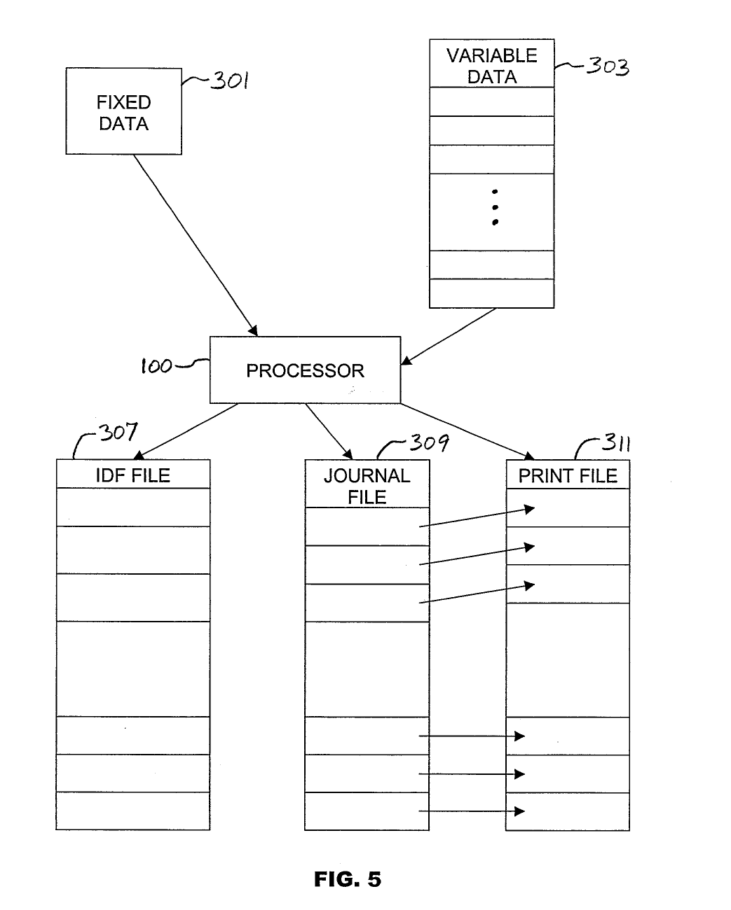

With reference to FIG. 4, the split variable data is received at one of the MPFs 1. There the data undergoes a number of processes, including composition/file generation as indicated at 207. According to a preferred embodiment, when the processor 100 at an MPF receives variable data, it first determines the fixed data associated with the mail job. Preferably, the fixed data is associated with an application program that inserts or merges variable data for each mail piece with the fixed data to create printable page images for each mail piece in the mail job. The processor 100 then requests the appropriate application program and associated fixed data from the SMF 3 (illustrated in FIG. 1).

The SMF 3 provides central storage for application programs and associated fixed data in the preferred embodiment. Maintaining the application programs at the SMF 3 is preferable to maintaining application programs at the individual MPFs 1 for at least two reasons. First, this simplifies the implementation of changes in an application program, as it is not necessary to update each copy of the application program and associated fixed data at multiple remote MPFs 1; second, the security of the fixed data and the application program is enhanced as multiple copies of the application program and fixed data are not stored at the various MPFs. Nevertheless, it is possible to maintain the application program(s) and fixed data at the MPF 1.

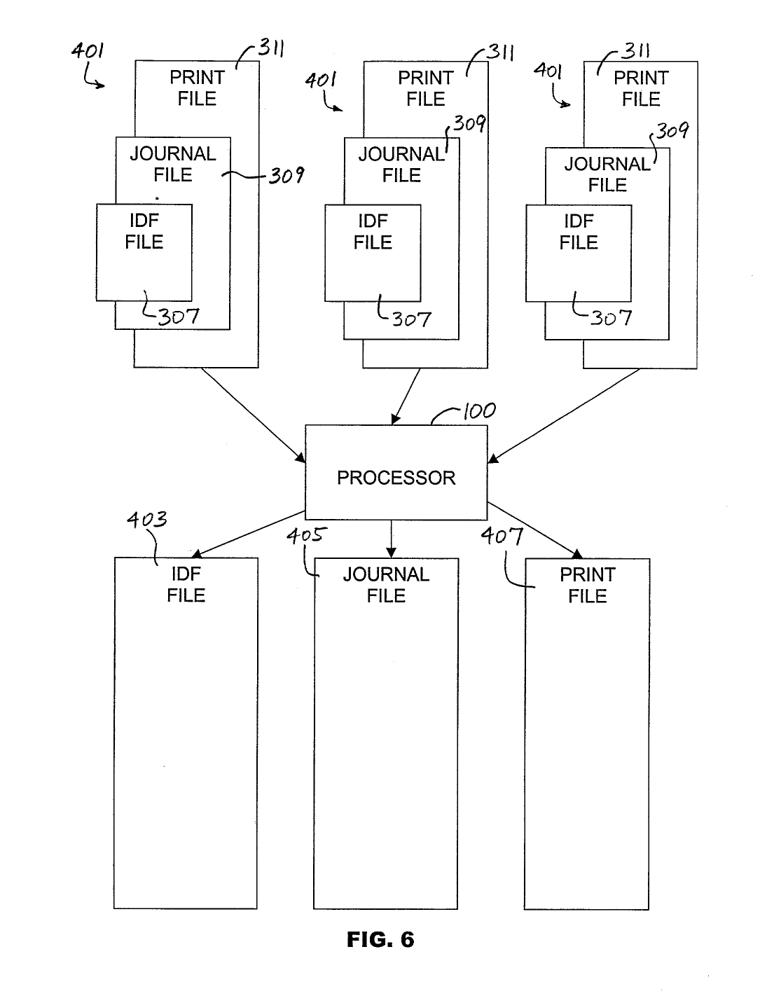

The application program is created in advance when a customer first arranges to have mail jobs processed by the system 10. The same application program may be used for many jobs, such as when a credit card company sends out monthly bills which are prepared each month using the same application program with a different set of variable data. As shown in FIG. 5, the application program in the processor 100 merges the fixed data 301 with variable data 303 and creates an image of each page to be printed for each mail piece in the mail job, and stores each image consecutively in a print file 311. The stream of collective image data, which is referred to herein as a print file, is also sometimes referred to as a print data stream. Image data is utilized in the preferred embodiment for several reasons, including the fact that high speed printers readily and most rapidly handle image data. The process by which the images are created, which is sometimes referred to in the art as composition, is indicated by element 207 in FIG. 4.

Customer data may be received in a variety of formats. Examples of two possible formats are shown below in Table 1:

TABLE 1

| Format 1 | Format 2 |
|---|---|
| Name (40 characters) | Key Code (10 characters) |
| Address 1 (40 characters) | Name, First + M.I. (20 characters) |
| Address 2 (40 characters) | Name, Last (20 characters) |
| Address 3 (40 characters) | Address 1 (50 characters) |
| City (20 characters) | Address 2 (20 characters) |
| State (2 characters) | City, State, Zip Code (50 characters) |
| Zip Code (5 characters) | Name (alternate) (50 characters) |
| Zip +4 (4 characters) | Other Data (200 characters) |
| Page Code (10 characters) | |
| Other Data (170 characters) | |

The fixed data 301 for each mail piece in a mail job may be the same or may be different. If portions of the fixed data are different, customer codes in the variable data define which portions of the fixed data are to be included in a particular mail piece. In Table 1, the Page Code in Format 1 and the Key Code in Format 2 are examples of such customer codes. If the fixed data are the same for all pieces in a job, the application program automatically includes the fixed data in all mail pieces in the job.

The creation of separate print files 311 for each job from individual customers ensures that no mail piece will include variable data from one customer and fixed data from another customer. This is especially important when security is an issue.

In addition to the print file 311, the processor 100 running the application program also creates an IDF file 307 and a journal file 309. These files will be described in detail below.

With respect to the journal file 309, the application program translates the variable data for the mail job from the customer's format to a standard format and stores this standardized information in the journal file. The journal file includes a separate record for each mail piece in the mail job.

In addition to standardizing the variable information, the journal file 309 includes a pointer or an address of the starting location in the print file 311 of each mail piece as well as the number of pages in each mail piece. In this manner, the journal file 309 acts as an index into the print file such that the individual pages of data that comprise a mail piece can be accessed. It should be noted that the journal file 309 is not static; rather, it is updated and added to by subsequent processes as described further below. Table 2 is an example of a journal file:

TABLE 2

| Field | Description |
|---|---|
| (name, length, char/number) | |
| Reserved, 1, C | Reserved field |
| zip 10, 10, C | 10 character Zip Code |
| DPBC, 2, C | Delivery Point Bar Code |
| VectorOffset, 10, C | Location of first page in the print file |
| PageImpr, 6, N | Length of mail piece in pages |
| OutEnvCnt, 1, N | 1 = outside envelope, 0 = no envelope |
| Insert, 1, N | Indicates whether an insert from shoe |
| | #1 should be placed into envelope |
| | for mail piece |
| Insert2, 1, N | Same as above for shoe #2 |
| Insert3, 1, N | Same as above for shoe #3 |
| Insert4, 1, N | Same as above for shoe #4 |
| PrintOrientation, 7, C | landscape or portrait |
| AFPFileName, 50, C | Filename of print file containing print |
| | images |
| LOT, 4, C | Line of travel: standard term, prescribed |
| | by USPS |
| LOT_Order, 1, C | Line of travel order: Standard term, |
| | prescribed by USPS |
| CART, 4, C | Carrier route |
| ImgMaster, 10, C | Identifier of an image that is associated |
| | with mail piece |
| MpcPgCnt, 6, N | Count of printed page images |
| PhysPgCnt, 6, N | Count of physical pages |
| Weight, 7, C | Weight of mail piece |
| Thickness, 7, C | Thickness of mail piece |
| Tray_Dest, 5, C | Zip code of tray |
| Group_Dest, 5, C | ? ? ? ? ? |
| Tray_No, 4, C | Physical number of tray |
| Piece_Postage, 6, C | Amount of postage required |
| Mailing_ID, 14, C | Unique mail piece number |
| Mail_Type, 3, C | |
| Rate_Category, 3, C | Type of presort, e.g., 3 digit, 5 digit, |
| | mixed state, etc. |
| Op_Endorsment, 41, C | Endorsement (required by certain U.S. |
| | postal reglations) |

The first 15 fields (from Reserved to CART) represent the journal file created by the application program and include preferred, but optional, fields. The remaining fields are added during subsequent processing. VectorOffset and PageImpr fields correspond to the starting address and pages information. The other file created by the application program is the IDF file 307. The IDF file 307 is used to control the insertion machinery and track each page of each mail piece. In preferred embodiments, each printed page of each mail piece includes a unique identifier such as a bar code and/or alphanumeric symbol embedded thereon that identifies the particular page and mail piece. The IDF file 307 includes a separate sequential record for each page of each mail piece. The record lists the unique identifier for each mail page. As each page from the printer for each mail piece is input to the inserter, the inserter reads the identifier for that page and compares it to the identifier in the corresponding record of the IDF file 307. If the identifier from the printed page does not match the identifier in the IDF file 307, an error is declared and the mail piece is rejected.

The IDF file 307 also includes a definition of which inserts are associated with that mail piece. As used herein, inserts are used to refer to pieces that are prepared in advance of the printing of the mail job and are inserted into the same envelope as the pages printed during the mail job. For example, a finished mail piece such as a credit card bill typically includes one or more pages printed during the mail job, such as the pages that have the individual account holder's address and charge transactions (variable data) printed on them along with other information such as the credit card issuer's address, logo, and payment terms (fixed data). The finished mail piece also includes a number of inserts such as a preprinted sales offer (e.g., an offer to join a discount shopping club) and a preprinted return envelope (referred to in the art as a customer reply envelope or CRE) in which the account holder's check and a portion of the statement are to be submitted to the card issuer for payment on the account. Although there are many advantages to using an IDF file, it may be omitted.

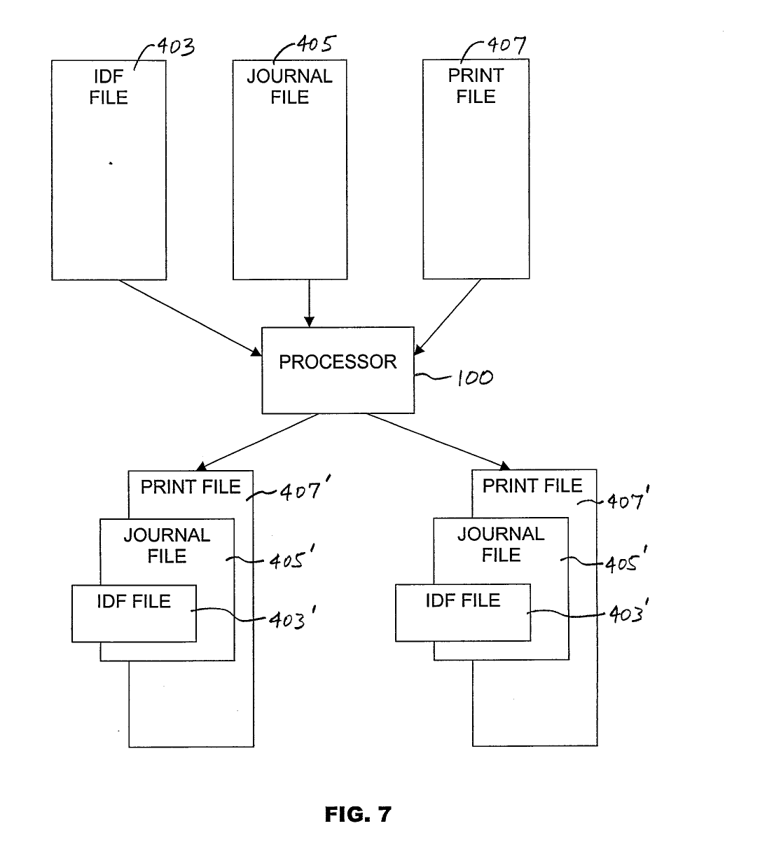

After the step 207 of composition and file generation, the result is that each mail job received has an associated IDF file 307, journal file 309, and print file 311. It is next desired to commingle the various mail jobs electronically. FIG. 6 illustrates the electronic commingling process step 209. Sets 401 of files output by the application program (the print file 311, the journal file 309, and the IDF file 307) are accumulated for several jobs. At a predetermined time, or when a predetermined number of jobs have been received at the MPF 1, the electronic commingling process 209 is initiated.

The electronic commingling process combines the output files (print file 311, journal file 309, and IDF file 307) from several mail jobs 401 from one or more customers into a combined IDF file 403, a combined journal file 405, and a combined print file 407.

In addition, a presort process 211 is run. Presorting is a well-known process by which mail pieces are sorted (usually geographically, such as by zip code) to containers such as letter trays in order to achieve the lowest possible total postal charges. As is well known in the art, presorting is not simply arranging the mail pieces in zip code order. Rather, presorting is a complex process in which, among other things, decisions as to how to group mail pieces together must be made. Because a commingled journal file 405 is created from the accumulated journal files from the individual jobs, the ability to achieve greater postal rate reductions in the presorting process is increased relative to separate presorts being performed for each of the separate jobs.

During presorting, each mail piece is also assigned to a destination container such as a letter tray as discussed above. The container number preferably matches the label to be assigned to the container, which in turn matches the local postal codes. For example, in the U.S., if the presort determines that the first 23 mail pieces belong together in the same container, and it is a simple 5 digit sort, then the container number is the 5 digit zip code. In the U.S., a letter tray typically holds 200 mail pieces. Thus, in the above example, there is only a partial tray. It should be noted that it is possible that more than 200 mail pieces will be assigned to a single tray. In this case, it simply means that there will be additional trays with the same label.

Preferably, the presorting process is performed on the commingled journal file 405 so as to re-order the journal file in accordance with the sorting criteria. As an example, Customer A's mail job may include 36 mail pieces to be sent to zip code “90210” along with many other mail pieces to be sent to other zip codes; Customer B's job may include 25 mail pieces to be sent to zip code “90210” along with other pieces to be sent to other locations. After presorting the journal file 405, the entries in the file corresponding to the 36 mail pieces of Customer A and the entries corresponding to the 25 mail pieces of Customer B will be grouped into the same portion of the file that corresponds to zip code “90210.” There will be one or more mail trays for receiving the commingled mail pieces for zip code “90210” for all of the customers. Each zip code represented in the commingled journal file is treated in this same fashion, like zip codes being grouped together.

Once the commingled journal file 405 has been created and presorted, the commingled print file 407 and commingled IDF file 403 are created based on the presorted, commingled journal file. As discussed above, each separate journal file 309 for each customer includes page location information (e.g., the start address of the first page in the mail piece and the total number of pages in the mail piece, or the addresses of each individual page in the mail piece) that allows each page image for each mail piece to be retrieved from the corresponding separate print file 311. The commingled print file 407 may be created by retrieving the page image location from each entry in the commingled journal file 405, using that page image location to retrieve the corresponding pages from the individual print files 311, and adding those page images to the commingled print file 407. The corresponding entry in the commingled journal file 405 is then updated to reflect the location of the page images in the commingled print file 407 (rather than the page location information in the individual print file 311).

Another important function advantageously performed at this point is page insertion. Because some mail jobs from some customers require only simplex printing (printing on only one side of a page) while other mail jobs require duplex printing (printing on both sides of a page), and because these jobs are being commingled, it may be necessary to insert a blank page after simplex page images to ensure that the next page image in the print file does not print on the back of the previous page. It should be noted that the page count maintained in the journal file 405 is not increased as a result of these blank pages. This is because the page count in the journal file is used for billing purposes and it may not be desirable to charge a customer for blank pages. However, the addresses in the journal file 405 should be modified to account for these blank pages as these blank pages are present in the print file 407 to properly space the pages.

A unique identifier, such as a bar code and/or alphanumeric ID code, preferably is inserted into each page image for each mail piece while transferring the page images to the commingled print file. The unique identifiers are preferably consecutively numbered. Thus, each page image of each mail piece in the commingled print file 407 will include a unique page identifier. The uses for the page identifier will be described further below.

The commingled IDF file 403 is created in a manner similar to that discussed above in connection with the creation of the commingled print file 407. That is, for each record in the individual journal file 309, the corresponding record is retrieved from a respective individual IDF file 307 and copied into the commingled IDF file 403 in the same order as the entries in the commingled journal file 405. In preferred embodiments, each record in the IDF file is fixed length, such that no separate index is necessary as the location can be determined with knowledge of the fixed record length. The process continues until all entries in the individual IDF files 307 have been added to the commingled IDF file 403.

At this point, the commingled files 403, 405, 407 have been completely sorted by the presort process. The commingled print file 407 includes images from a plurality of different mail jobs 401 and/or customers.

A potential problem occurs when different mail jobs require different processing. For example, an inserter may be capable of handling up to five different inserts at one time. If a commingled print file 407 contains images from ten different jobs, each from a different customer and each requiring a single but different insert, it is apparent that the mail pieces in the commingled files cannot be processed sequentially by the inserter. In order to account for this situation, a class division process is performed at step 213 in FIG. 4. FIG. 7 illustrates the class division process. The commingled files 403, 405, 407 are divided by class into a plurality of divided files 403′, 405′, 407′. If it is possible to process two or more classes at the same time, the corresponding files are included in the same divided file 403′, 405′, 407′. (Of course, it maybe the case that all of the jobs in the commingled file are capable of being processed without the need for any class division.) The container numbers for the mail pieces are not modified during the class division process 213.

Once the commingled files have been divided if desired, the printing and insertion processes (referred to in FIG. 4 as “production”) begin. Each divided print file is sent to the printer, which prints all of the pages in the file in the usual manner. Each of the printed pages includes a unique identifier such as the bar code as discussed above.

The output of the printer is fed to the inserter in a usual manner. The inserter also receives and reads the IDF file, if the IDF file is used. The inserter scans the bar code on each page received from the printer to determine whether the pages are in the order dictated by the divided IDF file. As the pages pass through the inserter, they are inserted into the mail piece envelopes along with the corresponding inserts (as defined in the IDF file) to create finished mail pieces. Since the addresses are printed on the mail piece, the envelope may include a window to show the address, thereby avoiding the need to address the envelopes and advantageously avoiding the possibility of incorrectly addressing the envelopes.

The finished mail pieces are placed into the containers to which they were assigned during the presort process 211. In preferred embodiments, the report produced during the presort process 211 is used by mail handling personnel to guide placement in the containers. In this manner, room is left in the trays for mail pieces from other of the divided files. For example, assume that a particular mail tray X holds 50 mail pieces and that 50 mail pieces, numbered 1550-1599, were assigned to that tray during the presorting process. When the first divided file is processed, there may be only twenty mail pieces in the 1550-1599 range produced. By referring to the report, mail handling personnel will place those twenty and only those twenty mail pieces in tray X. When the next divided file is processed, ten more mail pieces may be placed into tray X. When all of the divided files are processed, each mail tray may hold mail pieces from one or all of the divided jobs, and the entire mail piece output from all divided jobs will be commingled. Those of skill in the art will recognize that the placement of finished mail pieces in trays may also be automated.

The MPFs 1 described above could also be located on a worldwide basis. Such MPFs would preferably use international conventions for determining and correcting addresses. Preferably, the MPFs 1 are located fairly close to a post office, to provide for better transportation of finished mail to the post office. In some embodiments, the finished mail pieces of each MPF are taken to the nearest postal facility. In other embodiments, the finished mail pieces are transported to the corresponding local post offices. That is, for each MPF, each letter tray is shipped to the appropriate branch post office. This speeds up delivery of the mail pieces. This may also result in a reduction in postal fees.

Those of skill in the art will recognize that many variations to the preferred embodiment are possible. For example, it is possible to realize the advantages associated with electronic commingling in a system with a centralized production model (i.e., a system where jobs are produced at a central facility), or in a system with many production facilities where the customers send jobs to a central facility that in turn sends the jobs out to individual production facilities. Each of the functions of hygiene, address correction, geographic splitting, composition, electronic commingling, presorting, class division, and production can be performed either at a central facility or at an individual production facility. Furthermore, the creation of a journal file is just one method for electronically commingling mail jobs. Variations to the steps and order of the steps discussed in the preferred embodiment are also possible. For example, in the preferred embodiment, classes are assigned at the MPF 1, but it could alternatively (or additionally) be performed at the SMF 3. As another example, a commingled print file is formed from the individual print files and then the commingled print file is divided into divided print files in the preferred embodiments. It is also possible to commingle and divide the journal files first, and then assemble the divided print files directly from the individual print files. Still further, although there are security benefits associated with composing the print images before any commingling occurs, it is possible (and may even be desirable under some circumstances) to compose the print images after the variable data has been commingled. With regard to presorting, although it is preferable to presort the journal file and then assemble a print file therefrom, it is possible instead to first form the print file and then presort the print file.

Although the invention has been discussed in connection with hybrid mail, it can also be used for the production of same day documents with other mailing pieces that include color printing, and to create with the same electronic data an e-mail message.

The system management facility 3 could be provided as a distributed processor. The distributed facilities could be geographically separated, preferably networked such as by TCP/IP over a fully meshed frame relay network.

The “sorts” discussed herein could be performed by any appropriate sorting methodology, including use of sorted indexes.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for processing hybrid mail, comprising:
receiving at a hybrid mail facility a plurality of mail jobs from a plurality of senders, each mail job comprising variable data corresponding to a plurality of mail pieces to be produced;
generating an electronic data file for each mail job based on the variable data thereof, such that there are a plurality of said electronic data files; and
composing a commingled print file from the plurality of electronic data files, the commingled print file containing images to be printed for each of the plurality of mail jobs, the images including variable data and fixed data.

2. The method of claim 1, wherein the step of generating an electronic data file for each mail job comprises composing an individual print file for each mail job, each individual print file containing images to be printed for a respective one of the mail jobs, the images including variable data and fixed data, and wherein the commingled print file is composed by combining the individual print files for the plurality of mail jobs.

3. The method of claim 2, wherein the step of generating an electronic data file for each mail job further comprises generating an individual journal file corresponding to the individual print file for each mail job, each individual journal file including information indicating where in the individual print file the images are located for each mail piece in the mail job.

4. The method of claim 3, further comprising the step of generating a commingled journal file from the individual journal files, the commingled journal file including information indicating where in the commingled print file the images are located for each mail piece in each mail job.

5. The method of claim 1, further comprising the steps of assigning a class to each mail piece of each mail job on the basis of resources required to produce the mail piece, dividing the commingled print file into a plurality of class-divided print files such that each class-divided print file contains only images that can be printed using the same set of resources, and printing the class-divided print files.

6. The method of claim 1, further comprising the step of presorting the commingled print file.

7. The method of claim 6, wherein the step of presorting includes assigning a container code to each mail piece, the container code indicating which of a plurality of mail containers the mail piece is to be placed in after the mail piece is finished.

8. The method of claim 1, further comprising the steps of:
assigning a unique identifier to each image and including the identifier in the image such that each printed image on a page in a finished mail piece includes the identifier; and
reading the unique identifier on each page before inserting the page into an envelope of a mail piece to ensure that the page is inserted into the correct envelope.

9. The method of claim 1, wherein the mail jobs received at the hybrid mail facility are input from a central collection point.

10. The method of claim 1, wherein the mail jobs received at the hybrid mail facility are input from a plurality of separate sources.

11. The method of claim 1, further comprising the step of performing hygiene on the variable data for each of the mail jobs.

12. The method of claim 1, further comprising the step of performing address correction on the variable data for each of the mail jobs.

13. A method for processing hybrid mail, comprising:
receiving at a hybrid mail facility at least one mail job from each of a plurality of customers, each mail job comprising variable data corresponding to a plurality of mail pieces to be produced;
assigning each mail piece of each job to one of a plurality of classes;
composing an individual print file for each mail job, each individual print file comprising sets of images to be printed, each set of images corresponding to a finished mail piece, the images comprising variable data and fixed data;
combining the individual print files into a commingled print file comprising images from each of the individual print files;
dividing the commingled print file into a plurality of divided print files based on the class associated with the images in the commingled print file; and
printing each of the divided print files to produce printed pages for incorporation into finished mail pieces.

14. The method of claim 13, further comprising the steps of:
presorting the commingled print file to associate each mail piece with one of a plurality of containers into which finished mail pieces are to be placed;
assembling a plurality of finished mail pieces, the finished mail pieces including the printed pages; and
placing each of the finished mail pieces into the container that was associated with said mail piece in the presorting step.

15. The method of claim 14, further comprising creating an individual journal file corresponding to each individual print file for each mail job, each individual journal file indicating where the images for each mail piece are located in the corresponding individual print file, wherein the step of combining the individual print files into a commingled print file comprises combining the individual journal files to produce a commingled journal file and using the commingled journal file to assemble the commingled print file.

16. The method of claim 15, wherein the step of presorting comprises presorting the commingled journal file prior to assembling the commingled print file.

17. A system for processing hybrid mail, comprising:
a first processing facility operable to receive at least one mail job from each of a plurality of customers, each mail job comprising variable data corresponding to a plurality of mail pieces to be produced; and
a second processing facility in communication with the first processing facility and operable to receive variable data therefrom corresponding to mail jobs of two or more of said customers, the second processing facility including a processor operable to:
compose an individual print file for each of the mail jobs, the individual print file comprising sets of images to be printed by a printer, each set of images corresponding to a finished mail piece, the images comprising variable data and fixed data; and
combine the individual print files for the mail jobs into one commingled print file containing images from each of the individual print files.

18. The system of claim 17, wherein there are a plurality of second processing facilities located in diverse geographic locations, and the first processing facility is further operable to split the variable data for the mail jobs into a plurality of sets of split variable data each corresponding to one of the geographic locations and to transmit each set of split variable data to one of the second processing facilities based on said geographic location.

19. The system of claim 18, wherein the first processing facility is operable to perform hygiene on the variable data.

20. The system of claim 18, wherein at least one of the first and second processing facilities is operable to assign each mail piece of each job to one of a plurality of classes, and each second processing facility is operable to divide the commingled print file into a plurality of divided print files based on the class associated with the images in the commingled print file.

21. The system of claim 18, wherein each second processing facility is operable to presort the commingled print file.

22. The system of claim 18, wherein each second processing facility is operable to assign a unique identifier to each image to be printed on a page and to insert the identifier into each image in the commingled print file, the second processing facility including a printer that prints the commingled print file such that each printed page includes the unique identifier therefor.

23. The system of claim 22, wherein each second processing facility includes insertion equipment operable to read the unique identifier on each page before inserting the page into an envelope to ensure that the page is inserted into the correct envelope.

24. A system for processing hybrid mail, comprising:
a network of processing facilities operable to receive first variable data from a first customer and merge the first variable data with fixed data to form a first print file containing first images to be printed, to receive second variable data from a second customer and merge the second variable data with fixed data to form a second print file containing second images to be printed, to combine the first and second print files into a single commingled print file containing the first and second images, and to print the commingled print file to produce pages for insertion into finished mail pieces, whereby electronic commingling of customers' mail jobs occurs only after the images are created.

25. A system for processing hybrid mail, comprising:
a plurality of gateways each operable to receive sets of variable data from a plurality of sources, each set of variable data corresponding to a mail job for producing finished mail pieces, the variable data in each set being from one source;
a first processor connected to each of the gateways, the first processor being operable to:
receive a plurality of sets of variable data from the gateways;
split each of the sets of variable data into a plurality of split variable data sets in accordance with at least one criterion for distribution of the variable data; and
distribute the split variable data sets to a plurality of respective mail processing facilities in accordance with the at least one criterion for distribution; and
a plurality of mail processing facilities connected to the first processor, each mail processing facility including a second processor, a printer, and an inserter, the second processor being operable to:
compose a separate print file for each split variable data set received at the respective mail processing facility, the separate print file comprising sets of images to be printed, each set of images corresponding to a finished mail piece, the images comprising variable data and fixed data;
combining separate print files, regardless of the sources thereof, into a commingled print file comprising sets of images from each of the separate print files;
inserting a mail piece identifier in at least one image of each set of images in the commingled print file;
dividing the commingled print file into a plurality of divided print files based upon a class associated each set of images, the class being assigned to each set of images by one of the first and second processors; and
transmitting the divided print files to the printer to cause the printer to print each of the divided print files in turn to produce pages comprising images from the divided print files.

26. The system of claim 25, wherein the second processor is further operable to associate a container code with each set of images.

27. The system of claim 26, wherein the second processor is further operable to produce a report that matches container codes with mail piece identifiers.

28. The system of claim 25, wherein the first processor is located at a gateway.
